(19) United States
(12) Patent Application Publication
(10) Pub. No.: US 2008/0218496 A1
(43) Pub. Date: Sep. 11, 2008

(54) LIQUID CRYSTAL DISPLAY DEVICE

(75) Inventors: Chung Yong SONG, Seoul (KR); Min Seok KIM, Kyunggi-do (KR); Kyong Ho KIM, Gyeonggi-do (KR)

Correspondence Address: PEPPER HAMILTON LLP, ONE MELLON CENTER, 50TH FLOOR, 500 GRANT STREET, PITTSBURGH, PA, 15219, US

(73) Assignee: UNIDISPLAY, INC., Gyeonggi-do (KR)

(21) Appl. No.: 11/875,458

(22) Filed: Oct. 19, 2007

(30) Foreign Application Priority Data
Mar. 9, 2007 (KR) 10-2007-0023599

(51) Int. Cl. G06F 3/038

(52) U.S. Cl. 345/204

(57) ABSTRACT

The present invention generally relates to an LCD (Liquid Crystal Display) device, and more specifically, to an LCD device which comprises a driving circuit comprising: a data comparator for storing video data inputted in a previous stage from a timing generator, comparing size of the stored previous video data with video data inputted in the current stage, and for outputting a compared pre-emphasis voltage control signal; and an operational amplifier for adding pre-emphasis voltages to analog signals inputted from a D/A converter according to the pre-emphasis voltage control signal of the data comparator to amplify/output the signals.

### BACKGROUND

The present invention relates to an LCD device, and more specifically, to an LCD device which comprises a driving circuit for outputting an output video signal voltage by applying a pre-emphasis voltage, in a process of outputting the output video signal voltage by amplifying an input video signal voltage inputted to an output buffer.

The LCD device can be broadly classified into a transmissive type and a reflective type. LCoS (Liquid Crystal on Silicon) is a reflective LCD device that forms liquid crystal cells on a semiconductor substrate.

Unlike a common LCD which uses transparent upper/lower substrates, the LCoS injects liquid crystals between a semiconductor substrate and a transparent substrate, realizing high resolution at more than an HD TV grade in small size of approximately 1 inch by disposing switching circuits and components of each pixel with high integration. Recently, the LCoS is occupying the attention as a display of a projection system.

In a general LCoS display device shown in FIG. 1, cells that constitute pixels are disposed in array type, and each cell comprises liquid crystal cells, storage capacitors (C_{ST}), and NMOS transistors that perform switch functions.

Source electrodes of each NMOS are commonly connected in column direction to form data lines (D₁-Dₙ), and are connected to data switch control shift registers. Gate electrodes of each NMOS are commonly connected in row direction to form scan lines (S₁-Sₘ), and are connected to gate shift registers to realize a display device of N×M resolution. In FIG. 1, a display device of 4×4 resolution has been described for explanatory convenience.

When the pixel array is driven, degradation of liquid crystals may get accelerated if voltages are applied to the liquid crystals of the pixels in one direction only. Thus, video data voltages applied to the liquid crystals should be inverted in opposite polarity. A period to apply data voltages by changing in a direction opposite to a forward direction, is generally changed in every field, including a field inversion or frame inversion method for inverting voltage polarity of all pixels of a panel in every field at a time, a line inversion method for inverting the polarity by row line, a column inversion method for inverting by column line, and a dot inversion method for inverting by pixel.

In any case, pixel voltages (voltages applied to pixel electrodes connected to drains of NMOS transistors) are changed by turns so that the pixel voltages can be in positive (+) direction or negative (−) direction for a common voltage (V_{com}) when being inverted.

FIG. 2 is a circuit diagram of a general LCD) device. The LCD device comprises a timing controller for generating a timing control signal, a driving circuit for generating an on/off control signal of liquid crystal cells by using the timing signal generated from the timing controller, and the liquid crystals.

FIG. 3 illustrates a function block of a driving circuit of a general reflective LCD device, The driving circuit comprises a shift register, a latch unit composed of a sampling latch and a holding latch, a D/A converter, and a voltage output buffer. The shift register generates a clock for latching data from the sampling latch, and data signals for one line, which are sequentially stored in the sampling latch, are delivered to the holding latch and provided to the D/A converter. The D/A converter converts digital data into analog signals. A bias voltage decider is a circuit for deciding whether data voltages to be applied are forward data voltages or backward data voltages, and the voltage output buffer receives output of the D/A converter by using output of such logic, and outputs voltages to data lines of an LCoS panel.

FIG. 4 illustrates a voltage apply waveform (scan waveform) of a general reflective LCD device. The LCD device of FIG. 4 comprises 1920×1080 liquid crystal cells which express full HD, and among them, it is shown that gate signals are applied to 4 rows. Also, it specifically illustrates a timing diagram where video signals are applied to 1920 liquid crystal cells while a gate signal applied to a fourth row is activated. It is shown that the 1920 liquid crystal cells electrically connected to one row are driven by being divided into 120 blocks in total, so that video signals can be applied to 16 liquid crystal cells at a time. In case of driving of the general reflective LCD device, rows G1, G2, and G3 are sequentially selected by gate shift registers to turn on NMOS transistors of pixels on a uniform time basis. And, while the NMOS transistors of the pixels are turned on (scan time), data signal voltages outputted from a driving LSI (Large Scale Integration) unit are applied to the pixels, and are charged.

However, in case of a small-sized reflective LCD device, all data lines cannot be independently applied with voltages at the same time. Therefore, a driving LSI unit of the reflective LCD device has to charge all data lines with a limited number of outputs, resulting in a need of large-sized high-voltage switches between the data lines and output of the driving LSI unit. As for a high-resolution reflective LCD device, it is impossible to obtain sufficient time for charging data signal voltages outputted from the driving LSI unit in pixels.

FIG. 5 illustrates influence of high-voltage switches, capacitance, and resistance of data lines upon a signal. Supposing that a waveform created before passing through the data lines and the high-voltage switches equivalent to RC is a data signal outputted from a driving LSI unit, it is confirmed that the data signal which passes through the data lines and the high-voltage switches has an increase of charging and discharging time by RC delay owing to capacitors and resistance of the data lines and the high-voltage switches.

Thus, as resolution of the reflective LCD device is increased, given scan time, that is, time for turning on the NMOS transistors of the pixels is decreased, and time for charging and discharging the data signals in the pixels is reduced due to a limited number of outputs. Moreover, the reduction in the charging and discharging time of the data signals and the RC delay of the high-voltage switches and the data lines can prevent the data signals, which should be charged in the pixels within defined data signal charging and discharging time of the NMOS transistors, from being charged or discharged. Accordingly, there is a problem that desired data signals cannot be displayed on the pixels.

### SUMMARY

It is therefore an object of the present invention to provide an LCD device for comparing size of inputted video signal voltages with video signal voltages inputted in a previous stage and for outputting video signal voltages applied with pre-emphasis voltages on the basis of the compared results, in order to solve deficiency of charging and discharging time of data signals caused by RC delay of high-voltage switches and signal lines in a large-sized high-resolution LCD device.

In order to accomplish the above object, an LCD device, comprising: a driving circuit comprising: a timing generator for generating a timing control signal for each circuit part; a shift register for generating a shift signal according to the timing control signal; a latch unit for sampling and holding video digital signals applied from the outside according to the shift signal; and a D/A converter for converting the outputted digital signals of the latch unit into analog signals; and a liquid crystal cell array disposed in matrix type; and wherein the driving circuit, comprising: a data comparator for storing video data inputted in a previous stage from the timing generator, comparing size of the stored previous video data with video data inputted in the current stage, and for outputting a compared pre-emphasis voltage control signal; and an operational amplifier for adding pre-emphasis voltages to the analog signals inputted from the D/A converter according to the pre-emphasis voltage control signal of the data comparator to amplify/output the signals.

### BRIEF DESCRIPTION OF THE DRAWINGS

The advantages of the invention will become readily apparent to those skilled in the art from the following detailed description of a preferred embodiment when considered in the light of the accompanying drawings, in which:

FIG. 1 shows a liquid crystal cell array of a general LCoS display device;

FIG. 2 is a circuit format diagram of a general LCD device;

FIG. 3 is a function block diagram of a driving circuit of a general reflective LCD device;

FIG. 4 is a voltage apply timing diagram of a general reflective LCD device;

FIG. 5 is an input to output waveform diagram which illustrates the influence of high-voltage switches, capacitance, and resistance of data lines upon a signal;

FIG. 6 is a waveform diagram indicative of an input waveform and an output waveform of a voltage output buffer which constitutes a driving circuit;

FIG. 7 is a block format diagram of an LCD device driving circuit in accordance with the present invention;

FIG. 8 is a conceptual diagram of an operational amplifier having a pre-emphasis voltage generation function of an LCD device in accordance with the present invention;

FIG. 9 is an explanatory diagram for explaining operation of a pre-emphasis time generator;

FIG. 10 is an embodiment of an operational amplifier having a pre-emphasis voltage generator in accordance with the present invention; and

FIG. 11 is an embodiment of a circuit diagram that more specifically realizes falling transition of FIG. 9(a).

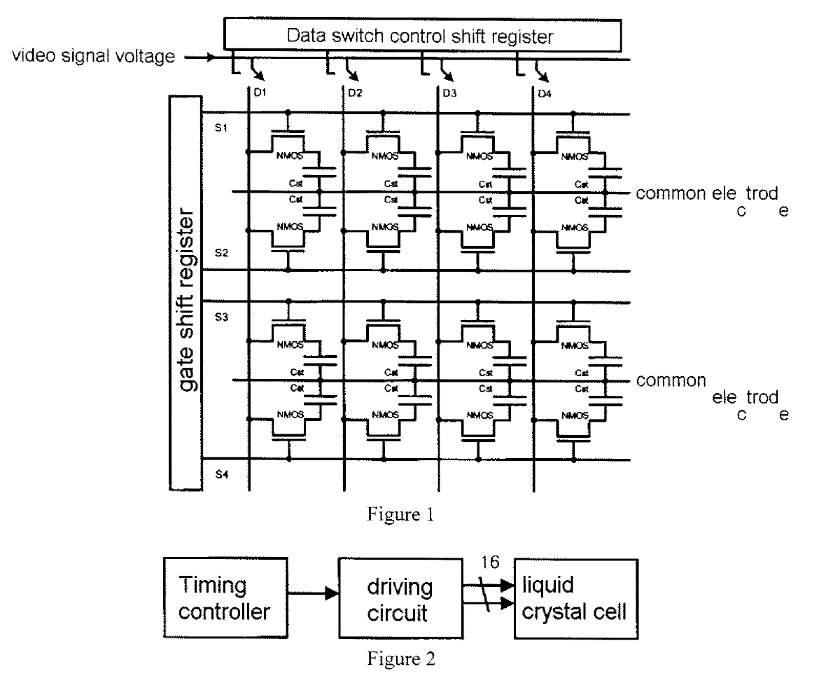

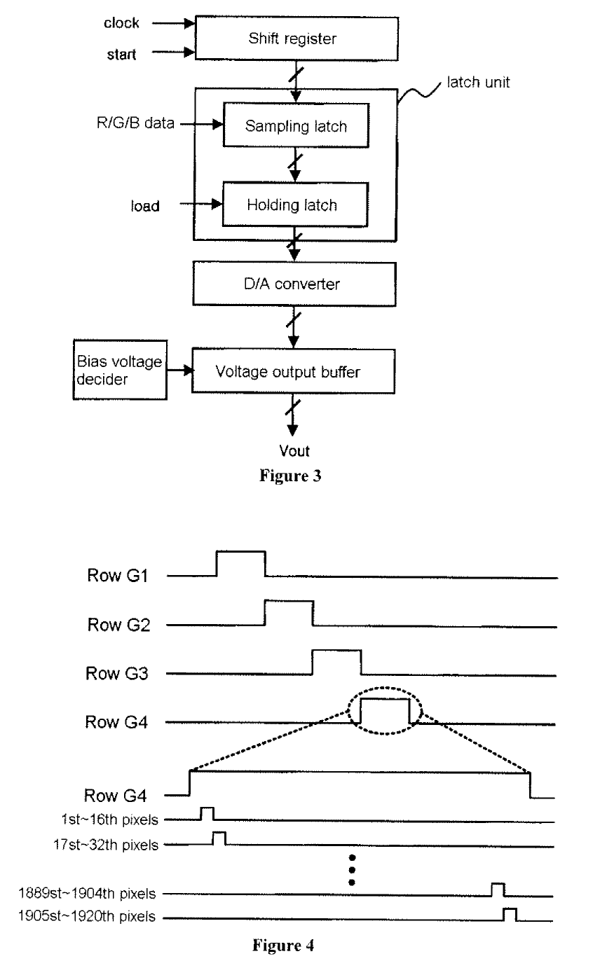

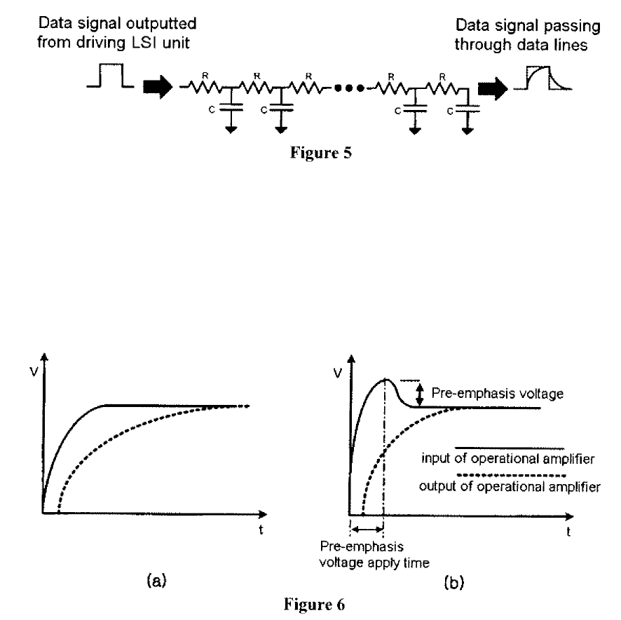

### DETAILED DESCRIPTION

The present invention will now be described more fully hereinafter with reference to the accompanying drawings, in which preferred embodiments of the invention are shown.

FIG. 6 is a waveform diagram indicative of an input waveform and an output waveform of a voltage output buffer which constitutes a driving circuit. FIG. 6(a) illustrates input and output waveforms of a prior voltage output buffer before a pre-emphasis voltage is applied, and FIG. 6(b) illustrates input and output waveforms of a voltage output buffer in accordance with the present invention. In comparison with FIG. 6(a) and FIG. 6(b), when the pre-emphasis voltage is applied as an input signal of an operational amplifier, it is confirmed that rising time of an output signal of the operational amplifier gets faster compared to a prior operational amplifier while delay time is reduced. Therefore, by providing outputted video signal voltages of an output buffer applied with the pre-emphasis voltage to data lines, it is possible to quickly charge and discharge the data lines up to desired video signal voltages. Like shown in FIG. 6(b), the pre-emphasis voltage and pre-emphasis voltage apply time are defined. Namely, the pre-emphasis voltage means a voltage value to maximum amplitude of an over-shooting voltage of the pre-emphasis voltage from maximum amplitude of a signal to which the pre-emphasis voltage is not applied. And, the pre-emphasis voltage apply time means a time taken for rising up to the maximum amplitude of the over-shooting voltage from a starting point.

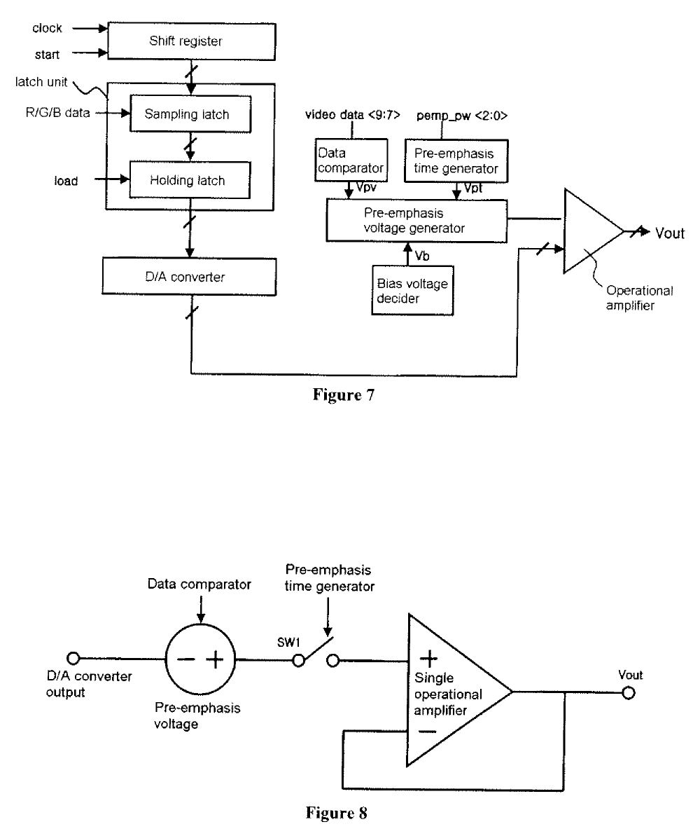

FIG. 7 is a block diagram of an LCD device driving circuit in accordance with the present invention. The driving circuit in accordance with the present invention is composed of a shift register, a latch unit comprising a sampling latch and a holding latch, a D/A converter, a bias voltage decider, a data comparator, and a voltage output buffer comprising a pre-emphasis time generator and a pre-emphasis voltage generator. The shift register generates a clock for latching data from the sampling latch, and data signals for one row, which are sequentially stored in the sampling latch, are delivered to the holding latch and provided to the D/A converter. The D/A converter converts digital data into analog signals. The data comparator is a circuit for comparing size of video signals applied in a previous stage with video signals applied in the current stage by using some of upper data bits which constitute video data inputted from the timing generator, and for outputting a compared pre-emphasis voltage control signal (Vₚᵥ). The pre-emphasis time generator is a circuit for outputting a control signal (Vₚₜ) for controlling a time when pre-emphasis voltages are applied, by using a pre-emphasis pulse width control signal (pemp_pw) inputted from the timing generator. The bias voltage decider is a circuit for outputting a bias control signal (V_{b}) by deciding whether data voltages to be applied are forward data voltages or backward data voltages. The pre-emphasis voltage generator generates pre-emphasis voltages according to the control signals of the bias voltage decider, the pre-emphasis time generator, and the data comparator, and the operational amplifier is a circuit for outputting an output signal (Vₒᵤₜ) to an LCD element by amplifying the analog signals inputted from the D/A converter according to the pre-emphasis voltage generator.

FIG. 8 is a conceptual diagram of an operational amplifier having a pre-emphasis voltage generation function of an LCD device in accordance with the present invention. It is known that the operational amplifier having the pre-emphasis voltage generation function in accordance with the present invention comprises a switch (sw₁) and a pre-emphasis voltage serially connected with an output signal of a D/A converter, on a non-inverted input terminal. A pre-emphasis voltage to be applied is determined by an output control signal of a data comparator, and operation time of the switch (sw₁) is determined by a pre-emphasis time generator.

An exemplary configuration and operation of the data comparator will be described as follows. The data comparator inputs 3 upper bits (9th pin, 8th pin, 7th pin) among video signals (10 bits in total) from the timing generator. Also, a separate memory is equipped, and 3 upper bit values are separately stored among video signals just inputted in a previous stage. Then, the 3 upper bits inputted in the current stage are compared with the 3 upper bits inputted in the previous stage to generate a pre-emphasis voltage control signal (Vₚᵥ) as a difference of the bits. More specifically, the pre-emphasis voltage applied when each of video data is inputted will be described through examples.

TABLE 1

| Classification | Current Bits | Previous Bits |
|---|---|---|
| Example 1 | 101 | 110 |
| Example 2 | 110 | 011 |

The example 1 of Table 1 indicates a case where 3 top bits have “101” among video signal inputs which are currently inputted and a case where 3 top bits have “110” among video signal inputs which are previously inputted. In this case, a third bit value “1” of the current video signal inputs and a third bit value “10” of the previous video signal inputs have a difference by “1”, and the rest of the two top bits are “10” and “11”, having a difference by “1” value only. Thus, it is decided that there is almost no difference between the current video signal input values and the previous video signal input values, and that a pre-emphasis voltage is not applied.

The example 2 of Table 1 indicates a case where 3 top bits have “110” among video signal inputs which are currently inputted and a case where 3 top bits have “011” among video signal inputs which are previously inputted, In this case, a third bit value “0” of the current video signal inputs and a third bit value “1” of the previous video signal inputs have a difference by “1”, but two top bits are “11” among the current video signal inputs while two top bits are “01” among the previous video signal inputs, which means that both parties have a difference by “2”. Therefore, a pre-emphasis voltage control signal (Vₚᵥ) corresponding to “2” is outputted.

The exemplified pre-emphasis data comparator employs a third bit as a reference value only among the 3 top bits of the video signal inputs, and does not recognize it as a substantial voltage difference. As a result, only two of the top bits are used, thus it is known that a voltage difference outputted from the pre-emphasis data comparator is counted in 4 stages to 3 from 0.

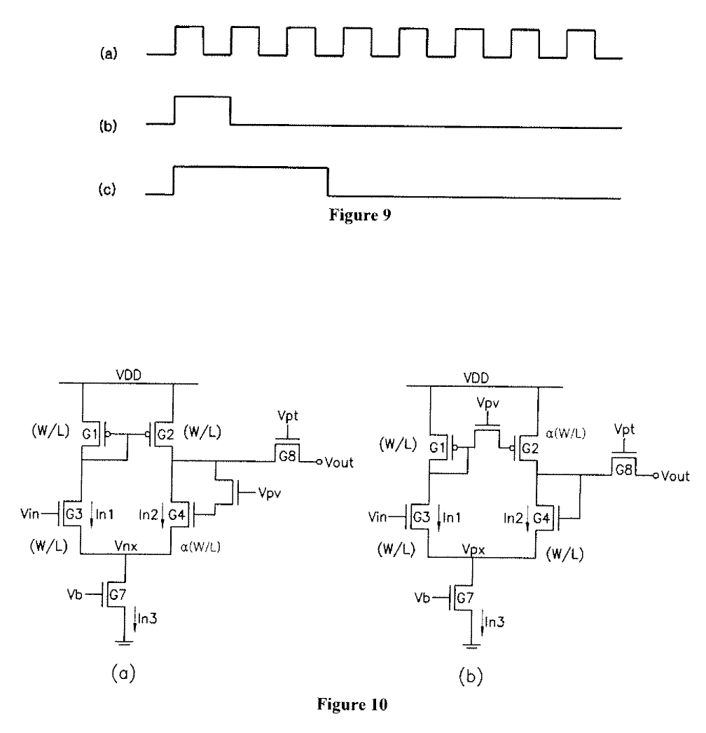

The pre-emphasis time generator is a circuit for controlling a time when a pre-emphasis voltage is applied by using a pre-emphasis pulse width control signal (pemp_pw) inputted from the timing generator. The pre-emphasis pulse width control signal (pemp_pw) inputted from the timing generator is composed of 3 bits, and application time of the pre-emphasis signal can be applied to “8” sections from “0” by using the inputted 3 bit values. FIG. 9 is an explanatory diagram for explaining operation of a pre-emphasis time generator, FIG. 9(a) illustrates an internal clock of the pre-emphasis time generator, FIG. 9(b) is a diagram of timing generated from the pre-emphasis time generator when “001” is applied as a pre-emphasis pulse width control signal, and a clock signal of FIG. 9(a) and an AND signal of the timing diagram of FIG. 9(b) are outputted as output signals, so a pre-emphasis signal (Vₚₜ) is applied as a clock 1. FIG. 9(c) is a diagram of timing generated from the pre-emphasis time generator when “011” is applied as the pre-emphasis pulse width control signal, and the clock signal of FIG. 9(a) and an AND signal of the timing diagram of FIG. 9(c) are outputted as output signals, so the pre-emphasis signal (Vₚₜ) is outputted as a clock 3.

FIG. 10 is one embodiment of an operational amplifier having a pre-emphasis voltage generator in accordance with the present invention. FIG. 10(a) is an embodiment circuit employed to apply an output signal for falling transition which is inverted into a backward voltage, and FIG. 10(b) is an embodiment circuit employed to apply an output signal for rising transition which is inverted into a forward voltage, realizing a current driving-type operational amplifier. Since circuit diagrams of FIG. 10(a) and FIG. 10(b) have the same substantial operation except the fact that mutually inverted signals are outputted, the circuit of FIG. 10(a) will be mainly explained while a difference only will be described for FIG. 10(b).

Transistors G1 and G2 operate as load transistors of a current mirror, and transistors G3 and G4 operate as differential input end transistors while a transistor G7 operates as a bias transistor, then a transistor G8 functions as an output switching transistor.

An output signal of a D/A converter is applied to a gate terminal (Vᵢₙ) of the transistor G3, and a gate terminal of the transistor G4 is connected to a drain terminal of the transistor G2 through a voltage control switching transistor. A pre-emphasis voltage control signal (Vₚᵥ) of a data comparator is applied to a gate terminal of the voltage control switching transistor, thereby controlling on/off actions of the transistor G4 according to the pre-emphasis control signal (Vₚᵥ) of the data comparator. An output signal (V_{b}) of a bias voltage decider is connected to an input end of the transistor G7. The transistor G8 is serially connected to an output end while an output signal (Vₚₜ) of a pre-emphasis time generator is connected to an input end of the transistor G8. The operational amplifier having the pre-emphasis voltage generator comprises a single gain operational amplifier, and employs a method for connecting the transistor G4 to an output end in parallel in spreading way, then is equipped with the transistor (G8) for controlling pre-emphasis time by being connected to the output end in serial.

During falling transition, an output error voltage between an output end and an input end is shown like an equation 1 in a circuit of FIG. 10(a). Equation 1 ignores the influence of the transistor G8 so as to simplify the development of the equation.

$${I}_{n 1} = {I}_{n 2} \\ \frac{{K}_{n}}{2} \cdot \frac{W}{L} \cdot ( {V}_{i n} - {V}_{nx} - {V}_{TH} ) 2 = \frac{{I}_{n 3}}{2} \\ {V}_{i n} - {V}_{out} = ( 1 - \frac{1}{\sqrt{a}} ) \sqrt{\frac{I \cdot L}{{K}_{n} \cdot W}} \qquad Equation 1$$

where:
Kₙ: Processor trans-conductance parameter defined by multiplication of oxide capacitance and electronic mobility of gate oxide;
V_{TH}: Threshold voltage of transistor;
L: Channel length of transistor;
W: Channel width of transistor; and
I: Current (Iₙ₃) flowing into bias transistor (G7).

Like being derived in the equation 1, a relation “Vin=Vout” is established if α=1, thus it shows a case where the pre-emphasis voltage does not have to be applied. If α=4, it shows that approximately 0.5V of a pre-emphasis voltage has to be applied.

Similarly, quantitative analysis of the circuit in accordance with the rising transition of FIG. 10(b) is the same as an equation 2. The circuit of FIG. 10(b) expresses the rising transition. While in FIG. 10(a), the transistor G4 is spread and the output signal (Vₚᵥ) of the data comparator is connected to a gate terminal of a control transistor of the spread transistor 64, the circuit of FIG. 10(b) has a difference that a transistor G2 is spread and the output signal (Vₚᵥ) of the data comparator is connected as a signal for controlling operation of the spread transistor G2.

Derivation of the equation 2 also ignores influence of the transistor G8 so as to simplify the development of the equation.

$$α \cdot {I}_{p 1} = {I}_{p 2} \\ \frac{{K}_{p}}{2} \cdot \frac{W}{L} \cdot ( {V}_{i n} - {V}_{px} - {V}_{TH} ) 2 = \frac{{I}_{p 3}}{1 + α} \\ {V}_{i n} - {V}_{out} = ( \sqrt{a} - 1 ) \sqrt{\frac{2 I \cdot L}{( 1 + α ) {K}_{n} \cdot W}} \qquad Equation 2$$

where:
Kₙ: Processor trans-conductance parameter defined by multiplication of oxide capacitance and electronic mobility of gate oxide;
V_{TH}: Threshold voltage of transistor;
L: Channel length of transistor;
W: Channel width of transistor; and
I: Current (Iₙ₃) flowing into bias transistor (G7).

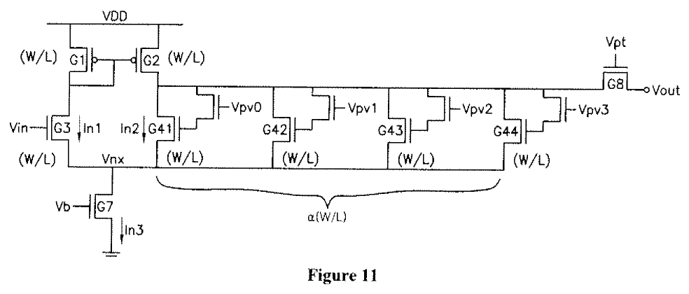

FIG. 11 is one embodiment of a circuit diagram that more specifically realizes falling transition of FIG. 10(a). In FIG. 11, Iₙ₂ means a sum of current values flowing into transistors G4, G5, and G6. Operation in case of falling transition will be qualitatively described in reference to FIG. 11. It is shown that the transistor G4 is spread into transistors G40, G41, G42, and G43. Suppose that “1111” is outputted as an output signal (Vₚᵥ) of a data comparator to turn “ON” all of the transistors G40, G41, G42 and G43. A value of a current Iₙ₁ and a value of a current Iₙ₂ flowing on both sides of a differential amplifier should be equally maintained, and the value of the current Iₙ₂ refers to a sum of current values flowing into the transistors G40, G41, G42 and G43, thus currents as much as I₁₂/4 individually flow into the transistors G40, G41, G42 and G43, and output voltages are reduced by ¼. Namely, it is possible to apply the pre-emphasis voltage which reduces a backward voltage in case of the falling transition. Separately, a transistor G8 is maintained in “ON” state during a clock by an output signal (Vₚₜ) of a pre-emphasis time generator, thereby determining application time of the pre-emphasis voltage.

As another operational example, if only one of the transistors G40, G41, G42 and G43 is maintained in “ON” state, it shows that the pre-emphasis voltage is not applied. And, if two of the transistors G40, G41, G42, and G43 are maintained in “ON” state, it is available to apply the pre-emphasis voltage which reduces by ½, as an output voltage.

In similar way, in the circuit of FIG. 10(b), the transistor G2 can be spread as well, and such a circuit configuration can be easily conducted by circuit designers engaged in the same or similar field, thereby omitting detailed explanations.

When a small-sized and high-resolution LCD device is driven by a driving method and a driving circuit of the present invention, data lines of an LCD panel are quickly charged and discharged thanks to a pre-emphasis voltage, thereby solving non-uniformity of display of the LCD device and charging/discharging errors caused by RC delay which is the largest problem when the small-sized and high-resolution LCD device is driven.

In accordance with the provisions of the patent statutes, the present invention has been described in what is considered to represent its preferred embodiment. However, it should be noted that the invention can be practiced otherwise than as specifically illustrated and described without departing from its spirit or scope.

Particularly, though the present invention has been described by mainly using a small-sized LCoS LCD device, the present invention is not limited to the LCoS LCD device, being widely usable for a driving circuit of a display device having matrix-type cells.

What is claimed is:

1. An LCD device, comprising:
a driving circuit, comprising;
a timing generator configured to generate a timing control signal for each circuit part,
a shift register configured to generate a shift signal according to the timing control signal,
a latch unit configured to sample and store video digital signals applied from the outside according to the shift signal,
a D/A converter configured to convert the outputted digital signals of the latch unit into analog signals,
a data comparator configured to store video data inputted in a previous stage from the timing generator, compare a size of the stored previous video data with video data inputted in the current stage, and output a compared pre-emphasis voltage control signal, and
an operational amplifier configured to add pre-emphasis voltages to the analog signals inputted from the D/A converter according to the pre-emphasis voltage control signal of the data comparator to amplify/output the signals; and
a liquid crystal cell array disposed in matrix type.

2. The LCD device of claim 1, wherein the data comparator is configured to compare the size of the video data inputted from the previous stage with the video data inputted in the current stage by using at least 2 top bits among the video data.

3. The LCD device of claim 2, wherein the operational amplifier comprises a current driving operational amplifier.

4. The LCD device of claim 2, wherein the driving circuit further comprises:
a pre-emphasis time generator configured to output a control signal that controls a time when the pre-emphasis voltages are applied, by using a pre-emphasis pulse width control signal inputted from the timing generator, and
wherein the operational amplifier is configured to add the pre-emphasis voltages according to a period in compliance with the control signal of the pre-emphasis time generator to amplify/output the signals.

5. The LCD device of claim 1, wherein the operational amplifier comprises a current driving operational amplifier.

6. The LCD device of claim 1, wherein the driving circuit further comprises:
a pre-emphasis time generator configured to output a control signal that controls a time when the pre-emphasis voltages are applied, by using a pre-emphasis pulse width control signal inputted from the timing generator, and
wherein the operational amplifier is configured to add the pre-emphasis voltages according to a period in compliance with the control signal of the pre-emphasis time generator to amplify/output the signals.

7. An LCD device, comprising:
a driving circuit, comprising:
a timing generator configured to generate a timing control signal for each circuit part,
a shift register configured to generate a shift signal according to the timing control signal,
a latch unit configured to sample and store video digital signals applied from the outside according to the shift signal,
a D/A converter for converting the outputted digital signals of the latch unit into analog signals,
a data comparator configured to store video data inputted in a previous stage from the timing generator, compare a size of the stored previous video data with video data inputted in the current stage, and output a compared pre-emphasis voltage control signal, and
an operational amplifier configured to add pre-emphasis voltages to the analog signals inputted from the D/A converter according to the pre-emphasis voltage control signal of the data comparator to amplify/output the signals; and
a liquid crystal cell array disposed in matrix type,
wherein the operational amplifier further comprises:
load transistors G1 and 62 of a current mirror, of which sources are connected to VDD power while gate electrodes are mutually connected,
a transistor G3 connected to a drain terminal of the transistor G1, and where an output signal of the D/A converter is connected to a gate electrode, and
a transistor G4 connected to a drain terminal of the transistor G2, and of which a gate electrode is connected to the drain terminal of the transistor G2 through a voltage control switching transistor, and wherein
source electrodes are connected to drain terminals of the transistors G3 and G4 while the drain terminals are connected to a ground, and bias voltages are applied to the gate electrodes.

8. The LCD device of claim 7, further comprising:
a transistor for controlling pre-emphasis time by being serially connected, wherein the transistor is between an output terminal of the operational amplifier and a drain terminal of the transistor G2.
